(19) United States
(12) Patent Application Publication
(10) Pub. No.: US 2025/0256653 A1
(43) Pub. Date: Aug. 14, 2025

(54) CONSOLE ASSEMBLY

(71) Applicant: Marelli North America, Inc., Southfield, MI (US)

(72) Inventors: Sanxiasky LEE, Warren, MI (US); Benjamin HARRIS, Troy, MI (US); Oleg ABRAMOVICH, Farmington Hills, MI (US); Justin BERRY, Owosso, MI (US); Michael ENGLISH, Royal Oak, MI (US)

(21) Appl. No.: 18/440,294

(22) Filed: Feb. 13, 2024

(51) Int. Cl. B60R 7/04; E05D 15/50

(52) U.S. Cl. CPC B60R 7/04; E05D 15/505

(57) ABSTRACT

A console assembly includes a box member, a lid member, a bracket, a first joint part, and a second joint part. The box member defines an opening. The lid member covers the opening of the box member. The bracket is disposed between the box member and the lid member. The first joint part pivotably couples the bracket and the box member about a first rotational axis extending along a first direction to switch the lid member between a closed position and a first open position in which the bracket is attached to the lid member. The second joint part pivotably couples the lid member and the bracket about a second rotational axis extending along a second direction perpendicular to the first direction to switch the lid member between the closed position and a second open position in which the bracket is attached to the box member.

### BACKGROUND

### Technical Field

The present disclosure generally relates to a console assembly. More specifically, the present disclosure relates to a console assembly that allows a lid to be opened from multiple directions that intersect each other.

### Background Information

A vehicle's passenger compartment typically includes a center console assembly between the front seats. U.S. Pat. No. 5,212,849 discloses an automobile console box with a lid that is opened and closed from two directions (i.e., the left and right sides).

### SUMMARY

The conventional console lid design lacks versatility, as it hampers the user's ability to effortlessly open and close the lid from multiple positions, including those of the driver seat, passenger seat, and second-row seating. This limitation diminishes the overall user experience and convenience.

One object of the present disclosure is to provide a console assembly that allows a lid to be opened and closed from multiple directions that intersect each other.

According to one embodiment of the present disclosure, a console assembly includes a box member, a lid member, a bracket, a first joint part, and a second joint part. The box member defines an opening. The lid member covers the opening of the box member. The bracket is disposed between the box member and the lid member. The first joint part pivotably couples the bracket and the box member about a first rotational axis extending along a first direction to switch the lid member between a closed position and a first open position in which the bracket is attached to the lid member. The second joint part pivotably couples the lid member and the bracket about a second rotational axis extending along a second direction perpendicular to the first direction to switch the lid member between the closed position and a second open position in which the bracket is attached to the box member.

The console assembly according to the embodiment of the present disclosure allows the user to open and close the lid from multiple directions, allowing the user to access and utilize the console storage regardless of where the user is seated. This enhances user satisfaction and provides a more user-friendly and adaptable automotive environment.

### BRIEF DESCRIPTION OF THE DRAWINGS

Referring now to the attached drawings, which form a part of this original disclosure:

FIG. 1 is a top schematic view of a vehicle equipped with a console assembly according to an exemplary embodiment;

FIG. 2 is a perspective view of a console assembly in accordance with an exemplary embodiment;

FIG. 3 is a perspective view of the console assembly in a state in which the lid member is opened from the rear side of the console assembly in accordance with the exemplary embodiment;

FIG. 4 is a perspective view of the console assembly in a state in which a lid member is opened from the left side of the console assembly in accordance with the exemplary embodiment;

FIG. 5 is a perspective view of the console assembly in a state in which the lid member is opened from the right side of the console assembly in accordance with the exemplary embodiment;

FIG. 6 is an exploded perspective view showing the lid member, a bracket, and a box member of the console assembly in accordance with the exemplary embodiment;

FIG. 7 is a bottom perspective view of a part of the lid member of the console assembly in accordance with the exemplary embodiment;

FIG. 8 is a perspective view showing a part of a frame structure, the box member, the bracket, and guide rods in accordance with the exemplary embodiment;

FIG. 9 is an exploded perspective view of a second or third joint part in accordance with the exemplary embodiment;

FIG. 10 includes diagrams for illustrating the operation of a displacement mechanism of the second or third joint part in accordance with the exemplary embodiment;

FIG. 11 is a schematic side view showing a first modified example of the displacement mechanism in accordance with the exemplary embodiment;

FIG. 12 is a schematic side view showing a second modified example of the displacement mechanism in accordance with the exemplary embodiment; and

FIG. 13 is a perspective view of a console assembly showing a modified example of the position of the latch mechanism in accordance with the exemplary embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

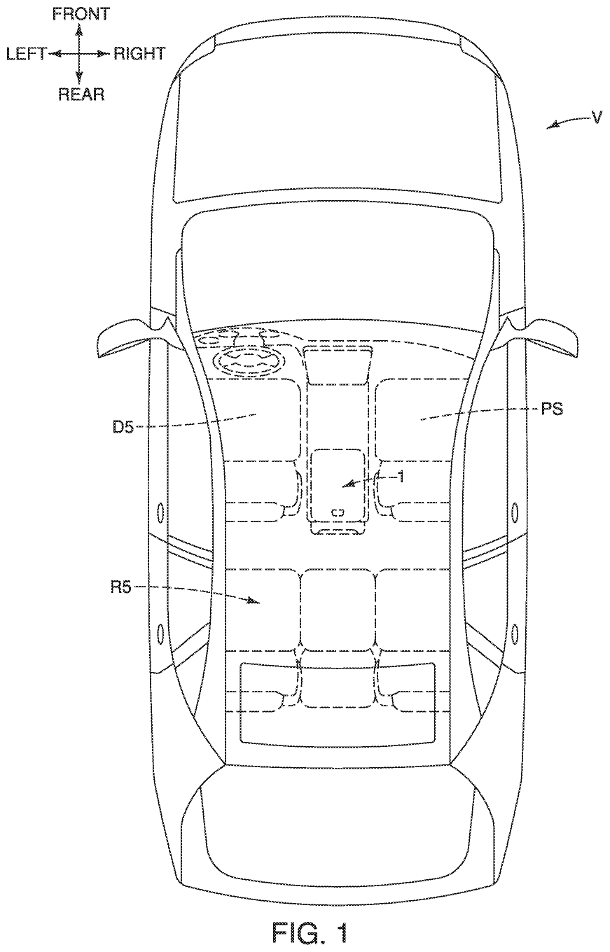

Referring initially to FIG. 1, a vehicle V having a console assembly 1 is illustrated in accordance with an exemplary embodiment. The vehicle V has a vehicle body that generally defines a passenger compartment. As shown in FIG. 1, the passenger compartment has an arrangement of passenger seats, including a front row of driver and passenger seats and a second or rear row of passenger seats. The vehicle V may also include additional rows of seating, as is the case for a typical large SUV, van, or bus. It should be appreciated that the vehicle V may be a motor vehicle, such as a wheeled car, sedan, coupe, truck, SUV, van, or bus, for example, or an airplane, train, boat, or other vehicle capable of transporting one or more passengers and personal items. The driver's seat may be on the left side of the vehicle, as shown in FIG. 1, or on the right side.

The console assembly 1 is located between the driver seat and the passenger seat. The console assembly 1 is supported on the floor of the vehicle V and may extend forward towards or near a dashboard at the front of the passenger compartment and may extend rearward to a position within reach of one or more passengers seated in the rear row of seats. In the embodiment, the rear portion of the console assembly 1 is positioned to allow a passenger seated on one of the seats on the second row to access the console assembly 1.

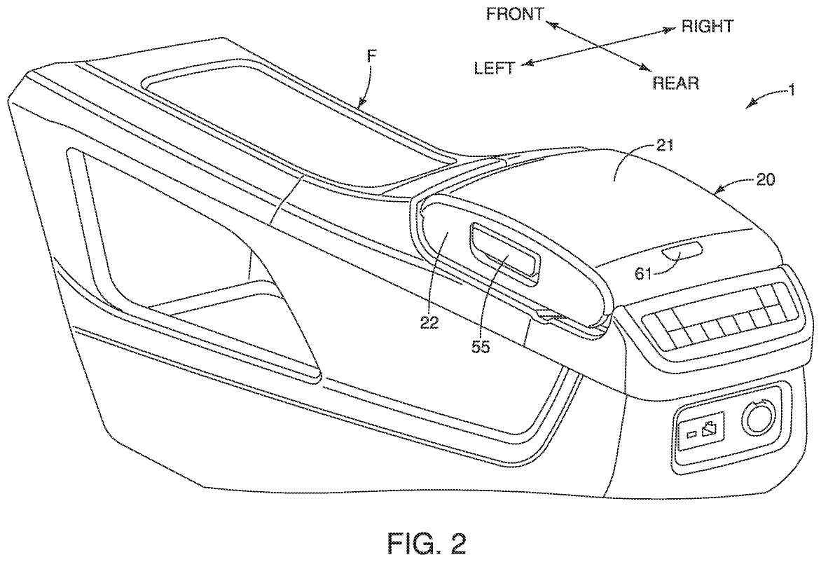

FIG. 2 is a perspective view of the console assembly 1 in accordance with the embodiment. The console assembly 1 includes a frame structure F, partially shown in FIG. 2, which is a structural support structure of the console assembly 1. The console assembly 1 includes a lid member 20 that covers an opening of a storage compartment when the lid member 20 is in a closed position shown in FIG. 2. The lid member 20 is configured to be opened and closed from multiple directions, allowing access to the storage compartment by the driver, the passenger, and the passenger(s) on the second-row seating. More specifically, in the embodiment, the lid member 20 is configured to be pivotably opened and closed from three sides, namely, the left side (from the driver seat), the right side (from the passenger seat), and the rear side (from the second-row seating). The console assembly 1 according to the embodiment allows the user to open and close the lid from multiple directions, allowing the user to access and utilize the console storage regardless of where the user is seated. This enhances user satisfaction and provides a more user-friendly and adaptable automotive environment.

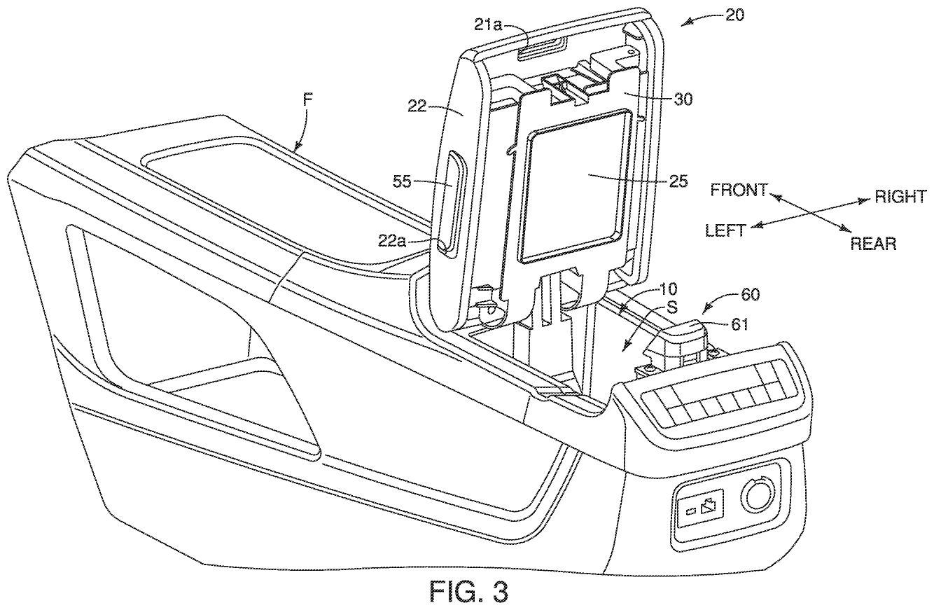

FIG. 3 is a perspective view of the console assembly 1 in a state in which the lid member 20 is in a first open position. In the embodiment, the first open position refers to a state in which the lid member 20 is opened from the rear side of the console assembly 1 so as to allow passenger(s) seated on the second-row seating to access the storage compartment.

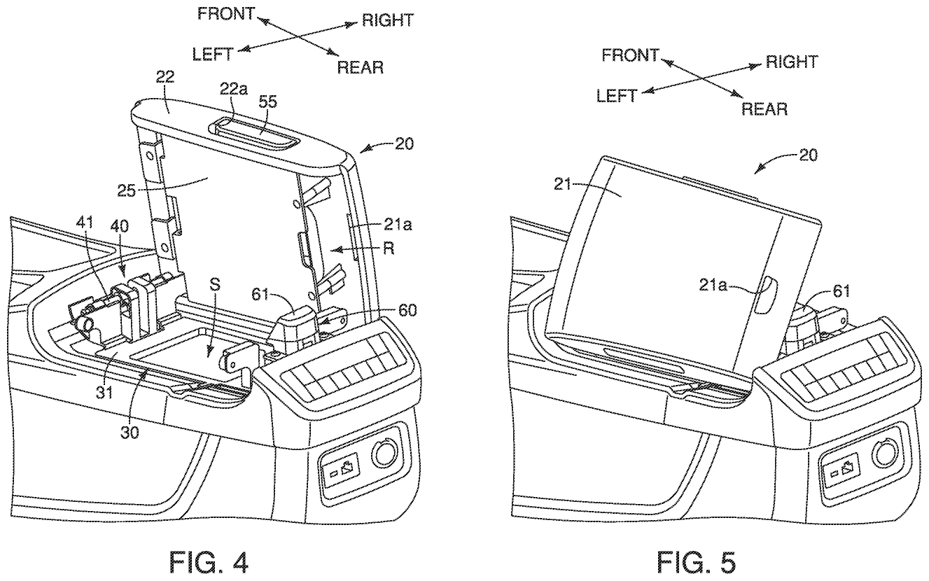

FIG. 4 is a perspective view of the console assembly 1 in a state in which the lid member 20 is in a second open position. In the embodiment, the second open position refers to a state in which the lid member 20 is opened from the left side of the console assembly 1 so as to allow the driver seated in the driver seat to access the storage compartment.

FIG. 5 is a perspective view of the console assembly 1 in a state in which the lid member 20 is in a third open position. In the embodiment, the third open position refers to a state in which the lid member 20 is opened from the right side of the console assembly 1 so as to allow the passenger seated in the front passenger seat to access the storage compartment.

As used herein, the terms first, second, and third “open position” encompass more than just the fully open state of the lid member 20; they include any degree of opening where the lid member 20 is not in the closed position.

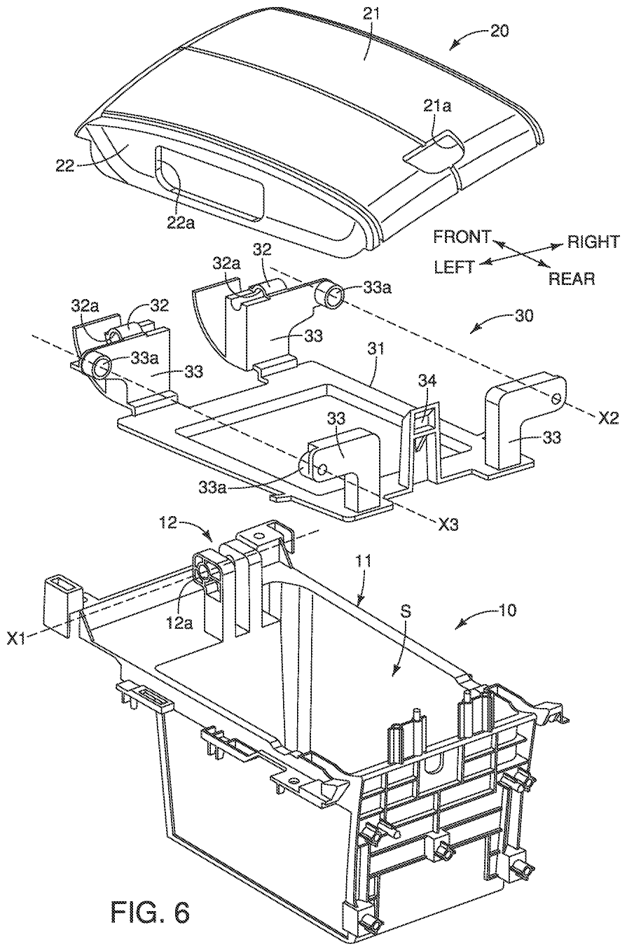

As shown in FIG. 6, the console assembly 1 includes a box member 10, the lid member 20, and a bracket 30 disposed between the box member 10 and the lid member 20.

The box member 10 is supported by the frame structure F. The box member 10 defines a storage compartment S that has an upper opening for access. More specifically, the box member 10 includes a box section 11 constituted by lateral walls and a bottom wall, and support portions 12 protruding upwardly at a front end portion of the box section 11. Each of the support portions 12 defines a through hole 12a extending along a lateral direction (the left-right direction of the vehicle V).

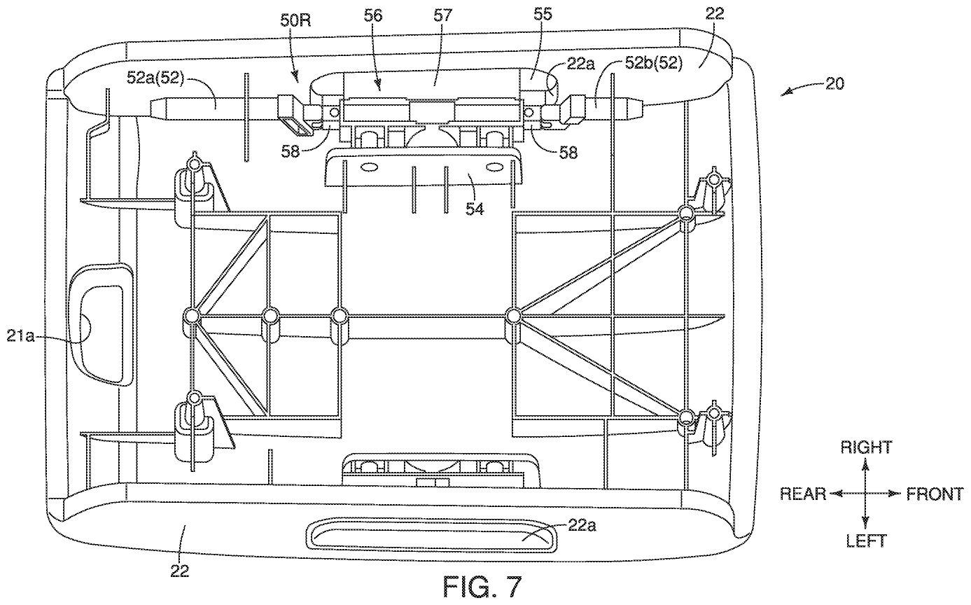

As shown in FIG. 2, the lid member 20 covers the opening of the box member 10 when the lid member 20 is in the closed position. As shown in FIGS. 6 and 7, the lid member 20 includes an upper wall 21, and a pair of side walls 22. The upper wall 21 defines an upper opening 21a at a rear end portion of the lid member 20. Each of the side walls 22 defines a side opening 22a. As shown in FIG. 7, the upper wall 21 and the side walls 22 define a recess R. As shown in FIGS. 3 and 4, the lid member 20 may include a bottom cover 25 that covers the recess R.

The bracket 30 includes a frame part 31 defining an opening that overlaps the opening of the box member 10 when the bracket 30 is attached to the box member 10. The bracket 30 further includes first support parts 32 and second support parts 33 protruding upwardly from the frame part 31. The first support parts 32 are arranged at the front end portion of the frame part 31. Each of the first support parts 32 defines a first through hole 32a extending along the lateral direction. Two of the second support parts 33 are arranged at the front end portion of the frame part 31, and two of the second support parts 33 are arranged at the rear end portion of the frame part 31. Each of the second support parts 33 defines a recess 33a that extends along the longitudinal direction (the front-rear direction of the vehicle V). The bracket 30 further includes a claw section 34 at the rear end portion of the frame part 31.

The console assembly 1 further includes a first joint part 40, a second joint part 50R and a third joint part 50L.

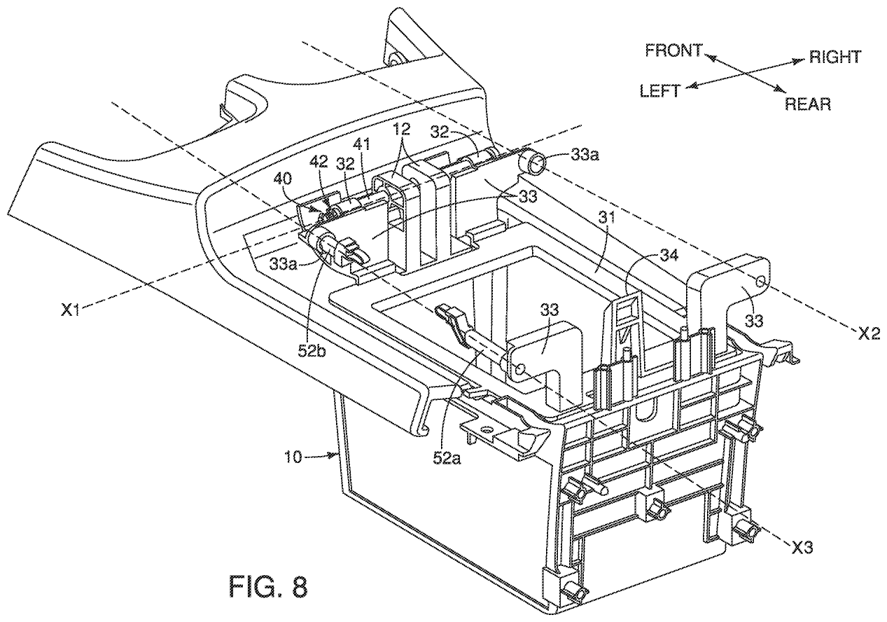

The first joint part 40 pivotably couples the bracket 30 and the box member 10 about a first rotational axis X1 (FIGS. 6 and 8) extending along the lateral direction to switch the lid member 20 between the closed position (FIG. 1) and the first open position (FIG. 2). In the first open position, the bracket 30 is attached to the lid member 20 via the second joint part 50R and the third joint part 50L as described in more detail below. As shown in FIG. 8, the first joint part 40 includes a rotational shaft 41 extending along a first rotational axis X1. The rotational shaft 41 extends through the through holes 12a of the support portions 12 of the box member 10 and the first through holes 32a of the first support parts 32 of the bracket 30 to pivotably couple the bracket 30 and the box member 10 about the first rotational axis X1. The first joint part 40 further includes biasing members 42 (e.g., springs) coupled to the rotational shaft 41 to apply a biasing force toward the first open position (FIG. 2).

Although the illustrated embodiment shows the first joint part 40 having a rotational shaft 41 that directly joins the box member 10 and the bracket 30, the scope of the present disclosure is not limited thereto. Any hinge structure that is configured to pivotably couple the box member 10 and the bracket 30 can be utilized as the first joint part 40. For example, a separate hinge member may be provided to pivotably couple the box member 10 and the bracket 30 about the rotational axis X.

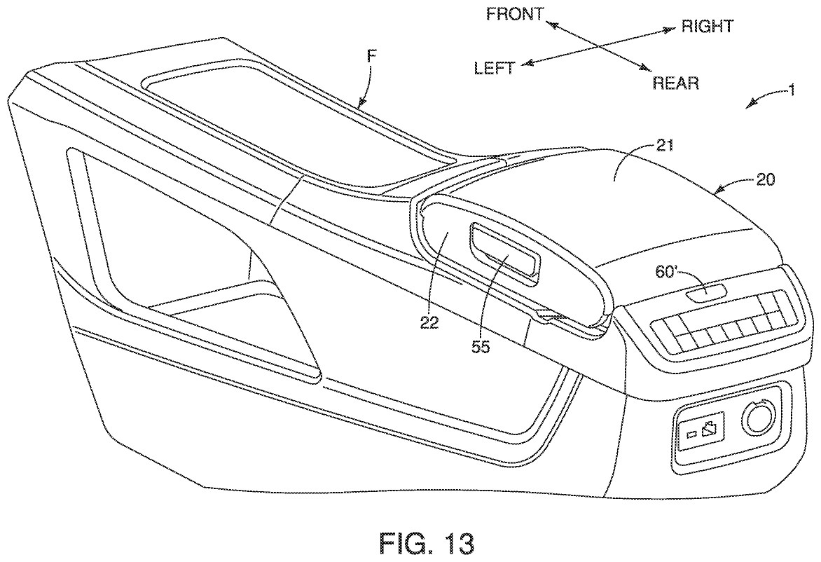

The console assembly 1 further includes a latch mechanism 60 that is configured to engage with the bracket 30, locking it in the closed position against the biasing force of the biasing member 42 of the first joint part 40. In this embodiment, the latch mechanism 60 includes a latch cam mechanism that interacts with the claw section 34 of the bracket 30. Pressing the knob member 61 of the latch mechanism 60 disengages it from the latch claw 34, causing the bracket 30 and the lid member 20 to pivot together around the first rotational axis X1. The knob member 61 is housed in the opening 21a of the lid member 20 when the lid member 20 is closed as shown in FIG. 2. The latch mechanism 60 is not limited to the structure shown in this embodiment. The latch mechanism 60 may employ any latch structure, such as a mechanical latch or a magnetic latch, designed to hold the bracket 30 in the closed position and release it when operated. Additionally, the position of the latch mechanism 60 is not limited to the one shown in this embodiment. For instance, the latch mechanism 60′ may be positioned on the rear portion of the frame structure F, as shown in FIG. 13. It is also possible to switch the positions of the latch mechanism 60 and the first joint part 40 (i.e., the first joint part 40 is arranged on the rear side and the latch mechanism 60 is arranged on the front side) if it is desirable for the lid member 20 to be opened/closed from the front side of the console assembly 1.

The second joint part 50R pivotably couples the lid member 20 and the bracket 30 about a second rotational axis X2 (FIG. 8) extending along a longitudinal direction (an example of a second direction) to switch the lid member 20 between the closed position (FIG. 1) and a second open position (FIG. 3). The third joint part 50L pivotably couples the lid member 20 and the bracket 30 about a third rotational axis X3 (FIG. 8) parallel to the second rotational axis X2 to switch the lid member 20 between the closed position (FIG. 1) and a third open position (FIG. 4). As shown in FIGS. 3 and 4, the bracket 30 is secured to the box member 10 by the latch mechanism 60 in the second and third open positions.

The second joint part 50R is a mirror image of the third joint part 50L. Consequently, only one of the second joint part 50R and the third joint part 50L is described below for the sake of brevity. Moreover, only the second joint part 50R is shown in FIG. 7 for the sake of brevity.

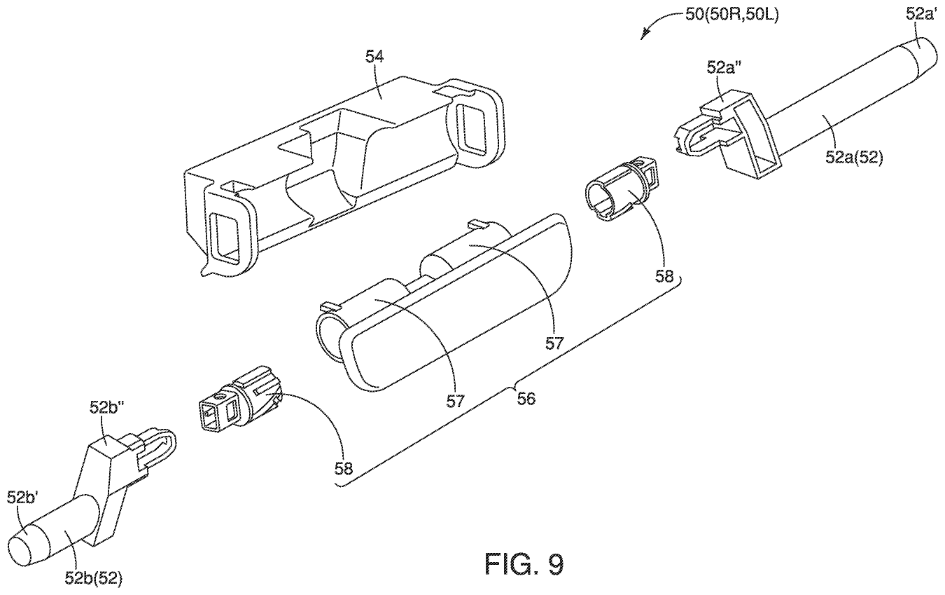

As shown in FIGS. 7, 9, and 10, the second joint part 50R includes a rod unit 52 and a displacement mechanism D1. The displacement mechanism D1 is configured to change an axial length of the rod unit 52 between a first length L1 and a second length L2 shorter than the first length L1. The rod unit 52 includes a pair of guide rods 52a and 52b. The displacement mechanism D1 is configured to change the axial length of the rod unit 52 by changing a distance between the guide rods 52a and 52b. The displacement mechanism D1 includes a knob part 55 rotatably coupled to the lid member 20, and a cylinder cam unit 56 operatively coupled to the knob part 55 to convert a rotational movement of the knob part 55 into an axial linear movement. The cylinder cam unit includes outer cylinder portions 57 integrally formed with the knob part 55, and inner cylinder portions 58 inserted in the outer cylinder portions 57. Each of the inner cylinder portions 58 includes a guide groove that operatively engages with a protrusion provided on the inner circumference of the corresponding one of the outer cylinder portion 57. The guide rods 52a and 52b include clip portions 52a″ and 52b″ that are respectively coupled to the inner cylinder portions 58. The cylinder cam unit 56 is rotatably coupled to the lid member 20 via a support base 54.

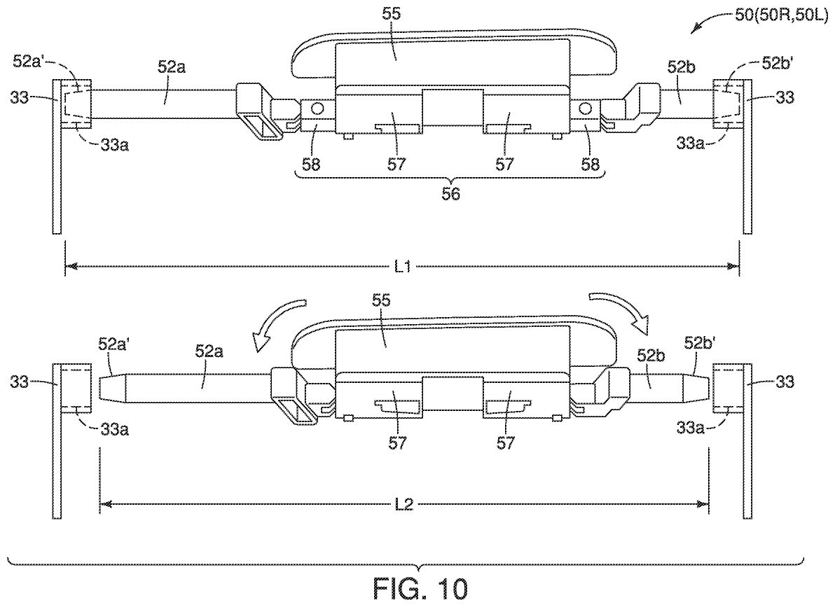

The displacement mechanism D1 further includes a biasing member (e.g., springs) applying a biasing force to maintain the rod unit 52 in the first length L1. Therefore, when the knob part 55 is in its initial position (i.e., not pressed), the rod unit 52 is maintained in the first length L1 so that the guide rods 52a and 52 b are rotationally coupled to the recesses 33a of the second support part 33 of the bracket 30. FIG. 8 shows a state in which the rod unit 52 of the third joint part 50L is in the first length L1 so that the guide rods 52a and 52b are coupled to the recesses 33a of the second support part 33 of the bracket. In FIG. 8, the parts of the third joint part 50L other than the guide rods 52a and 52b are omitted for the sake of brevity. When the user presses the knob part 55, the displacement mechanism D1 retracts the guide rods 52a and 52b to shorten the axial length of the rod unit 52 from the first length L1 to the second length L2, thereby releasing the guide rods 52a and 52b from the recesses 33a of the second support part 33 of the bracket 30. An axial end portion 52a′ or 52b′ of each of the guide rods 52a and 52b has a tapered shape so that the guide rods 52a and 52b are readily inserted into the recesses 33a when the knob part 55 is returned to its initial position. As shown in FIG. 10, axial lengths of the guide rods 52a and 52b are different from each other. Moreover, in this embodiment, the guide rod 52a arranged on the front side is shorter than the guide rod 52b arranged on the rear side. Therefore, the knob part 55 can be positioned closer to the front side for better accessibility. As shown in FIGS. 2-4, the knob part 55 is accommodated in the side opening 22a of the lid member 20. The structure of the displacement mechanism D1 is not limited to the one shown in the embodiment. Any mechanism that is configured to change the axial length of the rod unit 52 between the first length L1 and the second length L2 shorter than the first length L1 may be used as the displacement mechanism D1. The displacement mechanism D1 may be configured such that the axial length of the rod unit 52 between the first length L1 and the second length L2 is changed when the knob part 55 is pulled outwardly from the initial position.

Accordingly, when the lid member 20 is opened from the left side (the driver seat side), the knob part 55 of the displacement mechanism D1 of the third joint part 50L is pushed to release the guide rods 52a and 52b from the recesses 33a, while the displacement mechanism D1 of the second joint part 50R maintains the axial length of the rod unit 52 in the first length L1. Therefore, the lid member 20 is able to pivot about the rotational axis X2 into the second open position. On the other hand, when the lid member 20 is opened from the right side (the passenger seat side), the knob part 55 of the displacement mechanism D1 of the second joint part 50R is pushed to release the guide rods 52a and 52b from the recesses 33a, while the displacement mechanism D1 of the third joint part 50L maintains the axial length of the rod unit 52 in the first length L1. Therefore, the lid member 20 is able to pivot about the rotational axis X3 into the third open position.

When the lid member 20 is opened from the rear side, the knob parts 55 on both sides are in the initial positions. Therefore, the displacement mechanisms D1 of both the second joint part 50R and the third joint part 50L are configured to maintain the axial length of the rod units 52 in the first length L1. Thus, the lid member 20 pivots around the rotational axis X1 at the first joint part 40 in a state in which the bracket 30 is attached to the lid member 20 due to engagement of the guide rods 52a and 52b with the recesses 33a of the bracket 30 on both sides.

Similarly, when the lid member 20 is in the closed position, the displacement mechanisms D1 of both the second joint part 50R and the third joint part 50L are configured to maintain the axial length of the rod units 52 in the first length L1. Therefore, the lid member 20 is secured onto the bracket 30 with two rotating shafts (the rod units 52) on both sides. When a load is applied to the lid member 20, it can be supported at four points on both ends of the axis, making it load-bearing.

Moreover, the lid member 20 can be completely detached from the box member 10 by simultaneously pressing the knob parts 55 of both the second joint part 50R and the third joint part 50L. In such a case, the bracket 30 remains attached to the box member 10

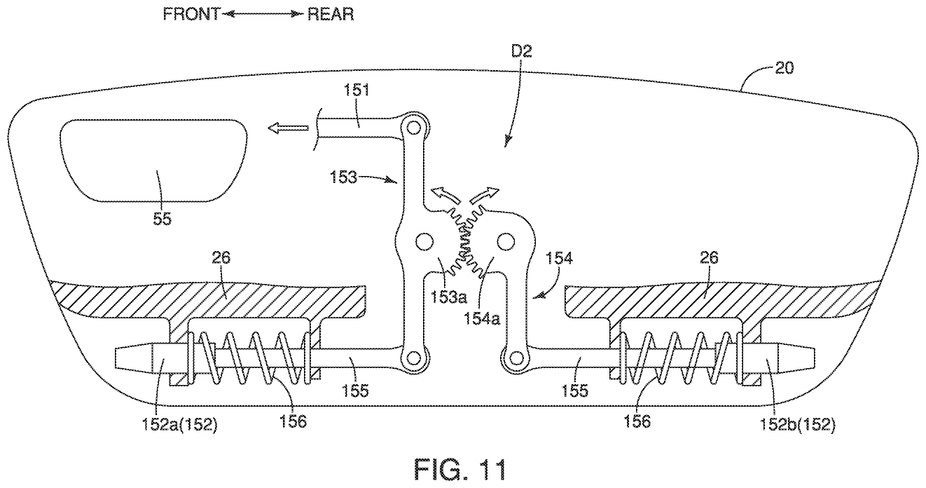

FIG. 11 is a schematic drawing showing a first modified example of a displacement mechanism D2. The displacement mechanism D2 includes a gear unit including gears 153a and 154a. When the user operates the knob part 55, it pulls the upper horizontal shaft 151 outward (i.e., towards the knob part 55), which in turn causes the lower horizontal shafts 155 to move inward due to the gear unit. This results in the guide rods 152a and 152b being released from the recesses 33a of the second support part 33 of the bracket 30. A similar mechanism as the displacement mechanism D1 may be used in the displacement mechanism D2 to pull the upper horizontal shaft 151 towards the knob part 55 when the knob part 55 is operated.

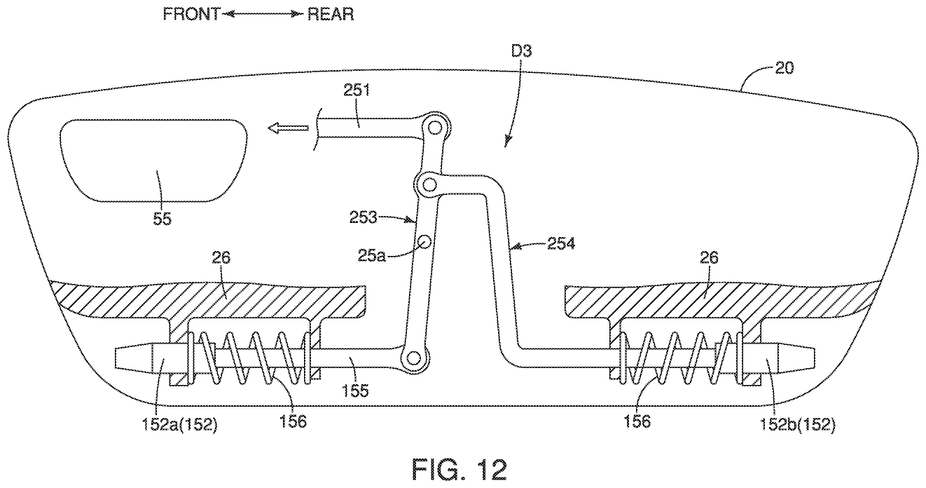

FIG. 12 is a schematic drawing showing a second modified example of a displacement mechanism D3. The displacement mechanism D3 includes a linkage unit including a pivotal lever 253 disposed between the knob part 55 and the rod unit 152. When the user operates the knob part 55, it pulls the upper horizontal shaft 251 outward (i.e., towards the knob part 55), which in turn causes the lower horizontal shaft 155 and the shaft 254 to move inward due to the pivotal lever 253 pivoting about the fixed pivot point 25a. This results in the guide rods 152a and 152b being released from the recesses 33a of the second support part 33 of the bracket 30. A similar mechanism as the displacement mechanism D1 may be used in the displacement mechanism D3 to pull the upper horizontal shaft 251 towards the knob part 55 when the knob part 55 is operated.

In the displacement mechanisms D2 and D3, the knob part 55 is disposed above the rod unit 152 (the guide rods 152a and 152b) with respect to a vertical direction of the lid member 20 when the lid member 20 is in the closed position. This arrangement allows for greater flexibility in the positioning of the knob part 55.

The console assembly 1 includes a box member 10, a lid member 20, a bracket 30, a first joint part 40, and a second joint part 50R. The box member 10 defines an opening. The lid member 20 covers the opening of the box member 10. The bracket 30 is disposed between the box member 10 and the lid member 20. The first joint part 40 pivotably couples the bracket 30 and the box member 10 about a first rotational axis X1 extending along a first direction (lateral direction) to switch the lid member 20 between a closed position (FIG. 2) and a first open position (FIG. 3) in which the bracket 30 is attached to the lid member 20. The second joint part 50R pivotably couples the lid member 20 and the bracket 30 about a second rotational axis X2 extending along a second direction (longitudinal direction) perpendicular to the first direction to switch the lid member 20 between the closed position (FIG. 2) and a second open position (FIG. 4) in which the bracket 30 is attached to the box member 10. The console assembly 1 may further include a third joint part 50L pivotably coupling the lid member 20 and the bracket 30 about a third rotational axis X3 parallel to the second rotational axis X2 to switch the lid member 20 between the closed position (FIG. 2) and a third open position (FIG. 5) in which the bracket 30 is attached to the box member 10.

Each of the second joint part 50R and the third joint part 50L includes a rod unit 52 and a displacement mechanism D1. The displacement mechanism D1 is configured to change an axial length of the rod unit 52 between a first length and a second length shorter than the first length. The rod unit 52 with the first length is rotationally coupled to the bracket 30 while the rod unit 52 with the second length is released from the bracket 30.

The displacement mechanism D1 of the third joint part 50L is configured to change the axial length of the rod unit 52 from the first length to the second length to switch the lid member 20 from the closed position to the second open position (FIG. 4) while the displacement mechanism D1 of the second joint part 50R maintains the axial length of the rod unit 52 in the first length, and the displacement mechanism D1 of the second joint part 50R is configured to change the axial length of the rod unit 52 from the first length to the second length to switch the lid member 20 from the closed position to the third open position (FIG. 5) while the displacement mechanism D1 of the first joint part 40 maintains the axial length of the rod unit 52 in the first length.

The displacement mechanism D1 of each of the second joint part 50R and the third joint part 50L further includes a biasing member applying a biasing force to maintain the rod unit 52 in the first length.

In each of the second joint part 50R and the third joint part 50L, the rod unit 52 includes a pair of guide rods 52a and 52b. The displacement mechanism D1 is configured to change the axial length of the rod unit 52 by changing a distance between the guide rods 52a and 52b.

An axial end portion 52a′ or 52b′ of each of the guide rods 52a and 52b has a tapered shape.

The displacement mechanism D1 includes a knob part 55 rotatably coupled to the lid member 20, and a cylinder cam unit operatively coupled to the knob part 55 to convert a rotational movement of the knob part 55 into an axial linear movement.

Axial lengths of the guide rods 52a, 52b are different from each other.

The knob part 55 is disposed above the guide rods 52a and 52b with respect to a vertical direction of the lid member 20.

The displacement mechanism D1 includes a gear unit (FIG. 11) disposed between the knob part 55 and the rod unit 52.

The displacement mechanism D1 includes a linkage unit (FIG. 12) including a pivotal lever disposed between the knob part 55 and the rod unit 52.

The displacement mechanisms D1 of the second joint part 50R and the third joint part 50L are configured to maintain the axial length of the rod units 52 in the first length when the lid member 20 is in the first open position FIG. 2.

The box member 10 includes a support part 12 defining a through hole 12a extending along the first rotational axis X1. The bracket 30 includes a first support part 32 defining a first through hole 32a extending along the first rotational axis X1. The first joint part 40 includes a rotational shaft 41 extending along the first rotational axis X1 through the through hole 12a of the support part 12 of the box member 10 and the first through hole 32a of the first support part 32 of the bracket 30.

The first joint part 40 further includes a biasing member 42 coupled to the rotational shaft 41 to generate a biasing force toward the first open position FIG. 2.

A latch mechanism 60 is configured to engage with the bracket 30 to hold the bracket 30 in the closed position.

The bracket 30 includes a frame part 31 defining an opening that overlaps the opening of the box member 10 when the bracket 30 is attached to the box member 10.

The bracket 30 includes a second support part 33 defining a recess 33a extending along the second rotational axis X2. The second joint part 50R includes a rod unit 52 and a displacement mechanism D1. The displacement mechanism D1 is configured to change an axial length of the rod unit 52 between a first length and a second length shorter than the first length. The rod unit 52 with the first length is inserted into the recess 33a of the second support part 33 of the bracket 30 while the rod unit 52 with the second length is spaced apart from the recess 33a of the second support part 33 of the bracket 30.

The lid member 20 defines a recess R. The second joint part 50R is housed within the recess R of the lid member 20.

A vehicle V includes the console assembly 1. The first direction is a lateral direction of the vehicle, and the second direction is a longitudinal direction of the vehicle.

The first joint part 40 is disposed adjacent to a front side of the box member 10.

The various portions of the vehicle not described herein are conventional components that are well-known in the art. Since these portions of the vehicle are well known in the art, these structures will not be discussed or illustrated in detail herein. Rather, it will be apparent to those skilled in the art from this disclosure that the components can be any type of structure that can be used to carry out the present invention.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “front”, “rear”, “above”, “downward”, “vertical”, “horizontal”, “lateral”, “below”, “longitudinal” and “transverse” as well as any other similar directional terms refer to those directions of a vehicle equipped with the console assembly. Accordingly, these terms, as utilized to describe the present invention should be interpreted relative to a vehicle equipped with the console assembly.

The term “configured” is used herein to describe a component, section or part of a structure that is constructed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature that is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A console assembly comprising:
a box member defining an opening;
a lid member covering the opening of the box member;
a bracket disposed between the box member and the lid member;
a first joint part pivotably coupling the bracket and the box member about a first rotational axis extending along a first direction to switch the lid member between a closed position and a first open position in which the bracket is attached to the lid member; and
a second joint part pivotably coupling the lid member and the bracket about a second rotational axis extending along a second direction perpendicular to the first direction to switch the lid member between the closed position and a second open position in which the bracket is attached to the box member.

2. The console assembly according to claim 1, further comprising
a third joint part pivotably coupling the lid member and the bracket about a third rotational axis parallel to the second rotational axis to switch the lid member between the closed position and a third open position in which the bracket is attached to the box member.

3. The console assembly according to claim 2, wherein
each of the second joint part and the third joint part includes a rod unit and a displacement mechanism, the displacement mechanism being configured to change an axial length of the rod unit between a first length and a second length shorter than the first length, the rod unit with the first length being rotationally coupled to the bracket while the rod unit with the second length being released from the bracket.

4. The console assembly according to claim 3, wherein
the displacement mechanism of the third joint part is configured to change the axial length of the rod unit from the first length to the second length to switch the lid member from the closed position to the second open position while the displacement mechanism of the second joint part maintains the axial length of the rod unit in the first length, and
the displacement mechanism of the second joint part is configured to change the axial length of the rod unit from the first length to the second length to switch the lid member from the closed position to the third open position while the displacement mechanism of the first joint part maintains the axial length of the rod unit in the first length.

5. The console assembly according to claim 4, wherein
the displacement mechanism of each of the second joint part and the third joint part further includes a biasing member applying a biasing force to maintain the rod unit in the first length.

6. The console assembly according to claim 4, wherein
in each of the second joint part and the third joint part,
the rod unit includes a pair of guide rods, and
the displacement mechanism is configured to change the axial length of the rod unit by changing a distance between the guide rods.

7. The console assembly according to claim 6, wherein
an axial end portion of each of the guide rods has a tapered shape.

8. The console assembly according to claim 6, wherein
the displacement mechanism includes a knob part rotatably coupled to the lid member, and a cylinder cam unit operatively coupled to the knob part to convert a rotational movement of the knob part into an axial linear movement.

9. The console assembly according to claim 6, wherein
axial lengths of the guide rods are different from each other.

10. The console assembly according to claim 6, wherein
the knob part is disposed above the guide rods with respect to a vertical direction of the lid member.

11. The console assembly according to claim 10, wherein
the displacement mechanism includes a gear unit disposed between the knob part and the rod unit.

12. The console assembly according to claim 10, wherein
the displacement mechanism includes a linkage unit including a pivotal lever disposed between the knob part and the rod unit.

13. The console assembly according to claim 3, wherein
the displacement mechanisms of the second joint part and the third joint part are configured to maintain the axial length of the rod units in the first length when the lid member is in the first open position.

14. The console assembly according to claim 1, wherein
the box member includes a support part defining a through hole extending along the first rotational axis,
the bracket includes a first support part defining a first through hole extending along the first rotational axis, and
the first joint part includes a rotational shaft extending along the first rotational axis through the through hole of the support part of the box member and the first through hole of the first support part of the bracket.

15. The console assembly according to claim 14, wherein
the first joint part further includes a biasing member coupled to the rotational shaft to generate a biasing force toward the first open position.

16. The console assembly according to claim 1, further comprising
a latch mechanism configured to engage with the bracket to hold the bracket in the closed position.

17. The console assembly according to claim 1, wherein
the bracket includes a frame part defining an opening that overlaps the opening of the box member when the bracket is attached to the box member.

18. The console assembly according to claim 14, wherein
the bracket includes a second support part defining a recess extending along the second rotational axis, and
the second joint part includes a rod unit and a displacement mechanism, the displacement mechanism being configured to change an axial length of the rod unit between a first length and a second length shorter than the first length, the rod unit with the first length being inserted into the recess of the second support part of the bracket while the rod unit with the second length being spaced apart from the recess of the second support part of the bracket.

19. The console assembly according to claim 18, wherein
the lid member defines a recess; and
the second joint part is housed within the recess of the lid member.

20. A vehicle comprising:
the console assembly according to claim 1, wherein
the first direction is a lateral direction of the vehicle, and
the second direction is a longitudinal direction of the vehicle.

21. The vehicle according to claim 20, wherein
the first joint part is disposed adjacent to a front side of the box member.
